(19) United States
(12) Patent Application Publication
(10) Pub. No.: US 2013/0293109 A1
(43) Pub. Date: Nov. 7, 2013

(54) LED DRIVER IC, DRIVING METHOD THEREOF, AND LED EMITTING DEVICE USING THE LED DRIVER IC AND THE DRIVING METHOD

(71) Applicants: Eun CHEON, Seoul (KR); Byunghak AHN, Seoul (KR); Jinhwa CHUNG, Seoul (KR); Young-Bae PARK, Anyang-city (KR)

(72) Inventors: Eun CHEON, Seoul (KR); Byunghak AHN, Seoul (KR); Jinhwa CHUNG, Seoul (KR); Young-Bae PARK, Anyang-city (KR)

(21) Appl. No.: 13/851,786

(22) Filed: Mar. 27, 2013

(30) Foreign Application Priority Data
May 2, 2012 (KR) 10-2012-0046517

(51) Int. Cl. H05B 33/08

(52) U.S. Cl. CPC H05B 33/0887
USPC 315/122

(57) ABSTRACT

The present invention relates to an LED driver IC, a driving method of the LED driver IC, and an LED light emission device using the LED driver IC. The LED light emission device includes an LED string, a power switch supplying power to the LED string, a dimming switch controlling light emission duty of the LED string, and an LED driver IC controlling switching operation of the power switch and the dimming switch. The LED driver IC senses a difference between a control electrode voltage of the dimming switch and a sense voltage generated according to a current flowing to the dimming switch, and triggers the OCP operation according to a result of comparison between the sensed voltage and a predetermined OCP reference voltage.

### CROSS-REFERENCE TO RELATED APPLICATION

This application claims priority to and the benefit of Korean Patent Application No. 10-2012-0046517 filed in the Korean Intellectual Property Office on May 2, 2012, the entire contents of which are incorporated herein by reference.

### BACKGROUND OF THE INVENTION

(a) Field of the Invention

The present invention relates to an LED driver IC, a driving method thereof, and an LED light emitting device using the LED driver IC.

(b) Description of the Related Art

An LED driver integrated circuit (IC) includes a dimming switch controlling dimming of an LED. Various protection operations are required to prevent the LED driver IC from being damaged due to unstable operation of the dimming switch. For example, the protection operations include over-current protection (OCP), direct-short protection (DSP), and open LED protection (OLP).

Recently, the LED driver IC is applied to a device that is driven with a high-output voltage, like a 3D TV backlight. The backlight is realized as an LED light emission device, and the LED driver IC for driving of the LED light emission device may include a dimming switch that controls dimming of the LED light emission device. For high-resolution and high contrast ratio, the 3D TV requires a backlight that is driven with a relatively high LED current compared to a conventional 2D TV.

In an abnormal state such as LED short-circuit, the backlight is turned off by an OCP function. When a user separates an AC power line from a socket outlet in the abnormal state, a VCC voltage supplied to the LED driver IC is decreased faster than an input voltage supplied to the backlight.

In this case, the dimming switch is not fully turned on when the decreasing VCC voltage is lower than a predetermined voltage (e.g., 9V). Then, a drain current flowing to the dimming switch is limited such that the LED driver IC cannot sense an over-current state and the OCP operation cannot be performed. That is, the current flowing to the dimming switch is limited such that the OCP is not performed without regard to the short-circuit state.

Thus, the switching operation of the dimming switch is maintained in the abnormal state, and the LED driver IC is damaged due to a power loss in the dimming switch.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an LED driver IC including a dimming switch performing abnormal protection operation in an abnormal state, a driver method of the LED driver IC, and an LED light emission device using the LED driver IC.

An LED driver IC according to an exemplary embodiment of the present invention controls light emission of an LED string and controls switching operation of a power switch that controls power supplied to the LED string. The LED driver IC includes: a dimming switch including a first electrode connected to the LED string and a second electrode connected to a sense resistor; and an OCP determining unit sensing a difference between a voltage corresponding to a control electrode voltage of the dimming switch and a sense voltage generated according to a current flowing to the sense resistor and triggering over-current protection (OCP) operation according to a comparison result of the sensed voltage difference with a predetermined first OCP reference voltage.

The voltage corresponding to the control electrode voltage of the dimming switch is a power voltage for operation of the LED driver IC, and the OCP determining unit generates an error voltage according to a voltage obtained by subtracting the sense voltage from the power voltage and generates a first dimming off signal that triggers the OCP operation according to a comparison result of the error voltage with the first OCP reference voltage.

The OCP determining unit includes: an error amplification unit including a first terminal to which the power voltage is input through a first resistor, a second terminal to which a voltage divided from the sense voltage by second and third resistors is input, and an output terminal connected with the first terminal through a fourth resistor, and generating an error voltage obtained by subtracting an input of the second terminal from an input of the first terminal; and a first OCP comparator including a first terminal to which the first OCP reference voltage is input and a second terminal to which the error voltage is input, and generating a first OCP signal that commands triggering of the OCP operation when the input of the first terminal is higher than the input of the second terminal.

The OCP determining unit further includes: a second OCP comparator generating a second OCP signal according to a comparison result of the sense voltage and a second OCP reference voltage that is different from the first OCP reference voltage; and an SR flip-flop including a reset terminal to which a signal corresponding to an auto-restart signal that controls auto-restart after the OCP operation is triggered and a set terminal to which an output of the second OCP comparator is input, generating a second OCP signal that commands triggering of the OCP operation according to an input of the set terminal, and resetting the second OCP signal according to an input of the reset terminal.

The OCP determining unit further includes a dimming off logic gate performing a logic operation on the first OCP signal and the second OCP signal, and generating the first dimming off signal when one of the first and second OCP signals commands the triggering of the OCP operation.

The LED driver IC further includes an over-voltage comparator generating a second dimming off signal that triggers the OCP operation when a voltage corresponding to an LED voltage supplied to the LED string is higher than a predetermined over-voltage reference voltage, and when the first and second dimming off signals performs the logic operation and thus one of the two signals triggers the OCP operation, a dimming off signal that turns off the power switch and the dimming switch is generated.

The OCP determining unit includes a voltage-current converter generating the error voltage and a first OCP comparator including a first terminal to which the first OCP reference voltage is input and a second terminal to which the error voltage is input, and generating a first OCP signal that commands triggering of the OCP operation when an input of the first terminal is higher than an input of the second terminal, and the voltage-current converter includes: a first error amplifier including a first terminal connected with the power voltage through a fifth resistor and a second terminal to which a predetermined reference voltage is input, and generating an output according to a voltage difference between the two terminals; a second error amplifier including a first terminal to which the reference voltage is input through a sixth and a second terminal to which the sense voltage is input, and generating an output according to a voltage difference between the two terminals; first and second transistors having gate electrodes to which the output of the first error amplifier is input: a first current mirror circuit mirroring a current flowing to the second transistor: a second current mirror circuit mirroring the current mirrored through the first current; third and fourth transistors having gate electrodes to which an output of the second error amplifier is input; a seventh current mirror circuit mirroring a current flowing to the third transistor; an eighth current mirror circuit mirroring the current mirrored through the seventh current mirror circuit; and a seventh resistor including a first terminal connected a node where the second current mirror circuit and the eighth current mirror circuit are connected and the second terminal of the first OCP comparator and a second terminal connected to a ground. A node of the first transistor and the second transistor is connected to the first terminal of the first error amplifier, a node of the third transistor and the fourth transistor is connected to the first terminal of the second error amplifier, and the error voltage is a first terminal voltage of the seventh resistor.

The voltage-current converter further includes a third current mirror circuit mirroring a current flowing to the first transistor, a fourth current mirror circuit mirroring the current mirrored through the third current mirror circuit, a fifth current mirror circuit mirroring a current flowing to the fourth transistor, and a sixth current mirror circuit mirroring the current mirrored through the fifth current mirror circuit.

The LED driver IC includes: a switching controller controlling switching operation of the dimming switch according to a dimming pulse signal that controls light emission duty of the LED string, and turning off the dimming switch by being synchronized by the first dimming off signal; and a gate driver generating a gate signal according to an output of the switching controller using a driving voltage and transmitting the gate signal to a control electrode of the dimming switch, and a voltage corresponding to a control electrode of the dimming switch is the driving voltage.

The OCP determining unit generates an error voltage according to a voltage obtained by subtracting the sense voltage from the driving voltage and generates a first dimming off signal that triggers the OCP operation according to a comparison result of the error voltage and the first OCP reference voltage, and the driving voltage corresponds to a power voltage for operation of the LED driver IC.

The LED driver IC further includes a switching controller turning off the power switch by being synchronized by the first dimming off signal.

The switching controller turns off the power switch when a voltage generated according to a current flowing to the power switch reaches an error amplification voltage generated according to a difference between the sense voltage and a predetermined reference voltage, and turns on the power switch according to a clock signal that controls switching operation of the power switch.

A driving method of an LED driver IC controlling switching operation that controls a power switch controlling power supplied to an LED driver and a dimming switch controlling light emission of the LED string according to another exemplary embodiment of the present invention includes: generating a difference between a voltage corresponding to a control electrode voltage of the dimming switch and a sense voltage generated according to a current flowing to a sense resistor; comparing the difference of the voltages with a predetermined first OCP reference voltage; and turning off the power switch and the dimming switch by triggering OCP operation according to a result of the comparison.

The voltage corresponding to the control electrode voltage of the dimming switch is a power voltage for operation of the LED driver IC, and the generating of the difference of the voltages includes generating an error voltage according to a voltage obtained by subtracting the sense voltage from the power voltage.

The comparing with the first OCP reference voltage includes generating a first OCP signal commanding triggering of the OCP operation when the first OCP reference voltage is higher than the error voltage.

The driving method further includes: generating a second OCP signal that depends on a result of comparison between the sense voltage and a second OCP reference voltage that is different from the first OCP reference voltage; auto-restarting that turns on the dimming switch and the power switch for every period unit after the OCP operation is being triggered; and terminating the auto-restart by the second OCP signal commanding triggering of the OCP operation or the first OCP signal commanding triggering of the OCP operation.

The voltage corresponding to the control electrode of the dimming switch is a driving voltage supplying a voltage that turns on the dimming switch or the power switch.

An LED light emission device including and LED driver IC according to another exemplary embodiment of the present invention includes: an LED string; a power switch supplying power to the LED string; a dimming switch controlling light emission duty of the LED string; and an LED driver IC controlling switching operation of the power switch and the dimming switch. The LED driver IC senses a difference between a voltage corresponding to a control electrode voltage of the dimming switch and a sense voltage generated according to a current flowing to the dimming switch and triggers OCP operation according to a comparison result of the sensed voltage and a predetermined first OCP reference voltage.

The voltage corresponding to the control electrode voltage of the dimming switch is a power voltage for operation of the LED driver IC, and the LED driver IC generates an error voltage according to a voltage obtained by subtracting the sense voltage from the power voltage and triggers the OCP operation according to a result of comparison between the error voltage and the first OCP reference voltage.

The voltage corresponding to the control electrode voltage of the dimming switch is a driving voltage supplying a voltage that turns on the dimming switch or the power switch, and the LED driver IC generates an error voltage according to a voltage obtained by subtracting the sense voltage from the driving voltage and triggers the OCP operation according to the comparison result of the error voltage and the first OCP reference voltage.

According to the exemplary embodiments of the present invention, an LED driver IC including a dimming switch that performs over-current protection operation in an abnormal state, a driving method of the LED driver IC, and an LED light emission device using the LED driver IC.

### BRIEF DESCRIPTION OF THE DRAWINGS

FIG. 1 shows an LED light emitting device including an LED driver IC according to an exemplary embodiment of the present invention.

FIG. 2 partially shows a configuration of a general LED light emitting device.

FIG. 3 shows a configuration of the LED driver IC.

FIG. 4 shows an OCP determining unit according to the exemplary embodiment of the present invention.

FIG. 5 is a waveform diagram of an input voltage, a power source voltage, and a drain current according to the exemplary embodiment of the present invention.

FIG. 6 shows a voltage-current converter according to another exemplary embodiment of the present invention.

FIG. 7 shows a voltage-current converter according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

An LED driver IC according to an exemplary embodiment of the present invention triggers OCP operation when a drain current flowing in a dimming switch reaches a predetermined threshold level. When the OCP operation is triggered, the LED driver IC turns off a power switch and the dimming switch. After that, a gate signal that turns on the dimming switch is generated for every auto-restart period to check whether an abnormal state is continued.

The power switch is a switch for controlling power supply for light emission of the LED string in the LED light emitting device. A voltage of the power supplied to the LED string is called an LED voltage, and a boost converter is used to generate to LED voltage VLED in an exemplary embodiment of the present invention. However, the present invention is not limited thereto.

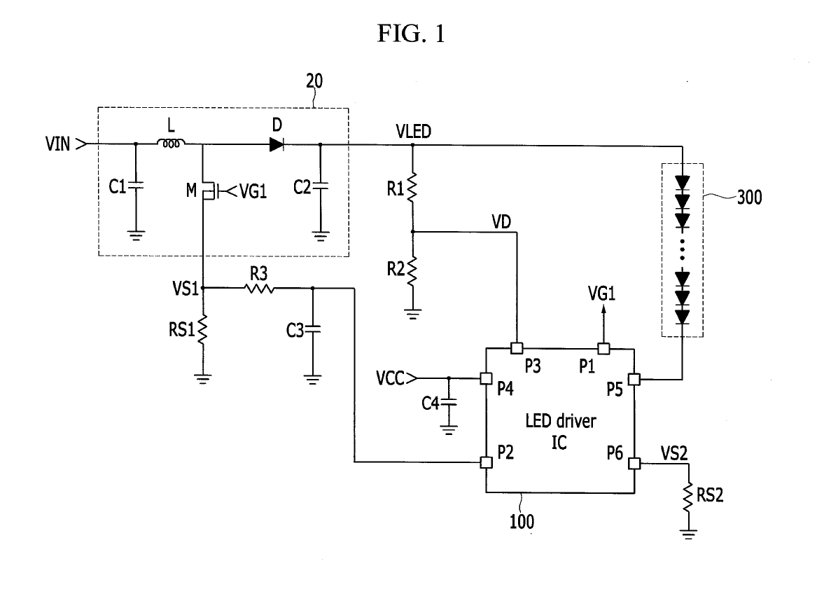

FIG. 1 shows an LED light emitting device including an LED driver IC according to an exemplary embodiment of the present invention.

An LED light emitting device 1 includes an LED driver IC 100, a boost converter 20, and an LED string 300.

The boost converter 20 includes an inductor L, a power switch M, a rectification diode D, and two capacitors C1 and C2.

The capacitor C1 smoothes an input voltage VIN. The inductor L includes a first terminal to which the input voltage VIN is transmitted and a second terminal connected to the power switch M and the rectification diode D.

The power switch M is connected between the second terminal of the inductor L and a ground. In further detail, a drain electrode of the power switch M is connected to the inductor L and an anode of the rectification diode D, and a source electrode of the power switch M is connected to the ground through a first sense resistor RS1. A gate electrode of the power switch M is connected to a connection pin P1 of the LED driver IC 100, and a first gate signal VG1 transmitted from the LED driver IC 100 is transmitted to the gate electrode of the power switch M.

The rectification diode D includes an anode connected to the second terminal of the inductor L and a cathode connected to the LED string 300.

The capacitor C2 smoothes a ripple component of the LED voltage VLED, which is an output voltage of the boost converter 20. The capacitor C2 is charged by an inductor current passed through the rectification diode D, an a voltage charged in the capacitor C2 becomes the LED voltage VLED.

The rectification diode D is not connected while the power switch M is in the turn-on state, and a current generated according to input voltage VIN flows to the inductor L and the power switch M. During this period, energy is stored in the inductor L.

The rectification diode D is connected while the power switch M is in the turn-off state, and an inductor current generated by the energy stored in the inductor L flows through the rectification diode D. The inductor current is supplied to the LED string 300 or charges the capacitor C2.

A first sense voltage VS1 generated in the first sense resistor RS1 by the drain current flowing during the turn-on state of the power switch M is passed through an RC filter formed of a resistor R3 and a capacitor C3 and then transmitted to the LED driver IC 100. In further detail, the first sense voltage VS1 is connected to a second pin P2 of the LED driver IC 100 through the RC filter.

The LED voltage VLED is divided according to a resistance ratio between the resistor R1 and the resistor R2. The resistance-divided voltage VD is connected to the connection pin P3 and transmitted to the LED driver IC 100.

A power voltage VCC is connected to a capacitor C4 and a connection pin P4. The input voltage VIN and the power voltage VCC are generated through an AC-DC converter (not shown) included in the LED light emitting device 1. The power voltage VCC is smoothed through the capacitor C4, and connected to the LED driver IC 100 through the connection pin P4. The LED driver IC 100 generates a voltage for operation using the power voltage VCC.

A first terminal of the LED string 300 is connected with the LED voltage VLED and a second terminal thereof is connected with a connection pin P5.

The LED driver IC 100 automatically restarts switching of the dimming switch and the power switch M when OCP operation caused by LED short-circuit is normally performed. A switching period by the automatic restart is set to be a short period to check whether an abnormal state such as the LED short-circuit is terminated. Then the abnormal state is checked during the automatic switching period, the LED driver IC 100 turns off the dimming switch and the power switch M when the automatic switching period is terminated.

The LED driver IC 100 automatically restarts the switching of the dimming switch and the power switch M after a predetermined period.

However, after AC power is blocked during the OCP operation state, the power voltage VCC is rapidly decreased but the input voltage VIN is maintained for a predetermined period. Since the boost converter 20 is not operated under the OCP condition, the boost converter 20 is in the no-load state. Accordingly, the input voltage VIN is hardly decreased, and only the power voltage VCC is rapidly decreased.

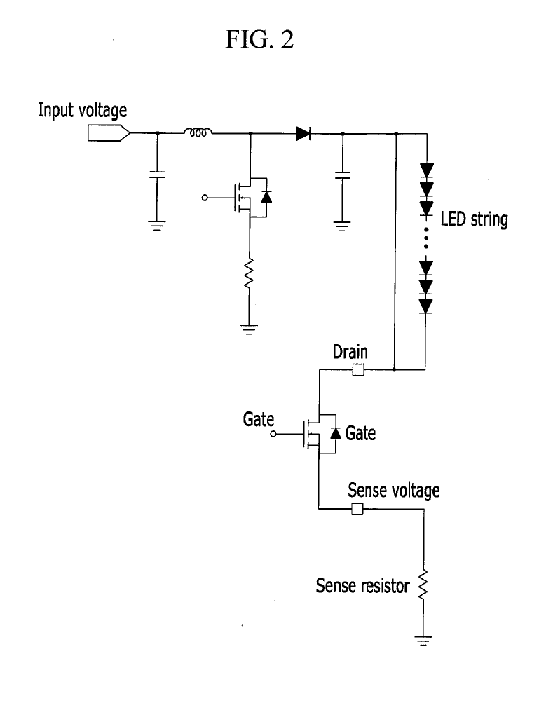

FIG. 2 partially shows a configuration of a general LED light emitting device.

As shown in FIG. 2, a high-level input voltage is supplied to a dimming switch when LED short-circuit occurs. A sense voltage generated in the sense resistor according to the increase of the short-circuit current is also increased. Then, a source voltage of the dimming switch is increased and thus a gate-source voltage is decreased. When the gate-source voltage is low, a drain current flowing to the dimming switch is limited.

That is, the LED short-circuit occurs, the short-circuit current is increased to be higher than a predetermined threshold level such that the OCP operation is triggered. After the OCP operation is triggered, an input voltage is maintained for a predetermined period but the power source voltage is decreased.

A conventional LED driver IC may not be able to normally perform an OCP operation when a decreasing power voltage is decreased close to an under-voltage lock out (UVLO) voltage. For example, the OCP is triggered when a drain current is higher than a predetermined threshold level, and the drain current is decreased due to a decrease of the power voltage VCC such that the drain current cannot be higher than the predetermined threshold level. That is, since the drain current of the dimming switch is decreased due to the decrease of the power voltage VCC, the OCP may not be normally triggered under the LED short-circuit condition.

In further detail, a gate-source voltage is decreased due to the decrease of the power voltage, and the current flowing to the dimming switch is decreased. In order to trigger the OCP operation, the drain current should be higher than a predetermined reference value. However, the current of the dimming switch is decreased, and according to the OCP operation is not triggered.

Thus, the switching operation of the dimming switch is continued and the drain current is decreased, and according to the duty of the dimming switch is gradually increased. While this condition is continued, the dimming switch is damaged by a high-level input voltage, and high-level drain current flows through the damaged dimming switch.

Thus, the LED driver IC 100 according to the exemplary embodiment of the present invention further includes a configuration that stops switching operation according to a difference between the power voltage VCC and the sense voltage VS2.

In the exemplary embodiment of the present invention, the power voltage VCC and the sense voltage VS are used to sense the decrease of the gate-source voltage of the dimming switch DFET. However, the present invention is not limited thereto, and the power switch M or a driving voltage DRV output from a gate driver of the dimming switch DFET may be used instead of using the power voltage VCC. The driving voltage DRV is an enable-level voltage that turns on the power switch M and the dimming switch DFET.

Since the power switch M and the dimming switch DFET are realized as n-channel type transistors, the enable level of the driving voltage DRV is high level.

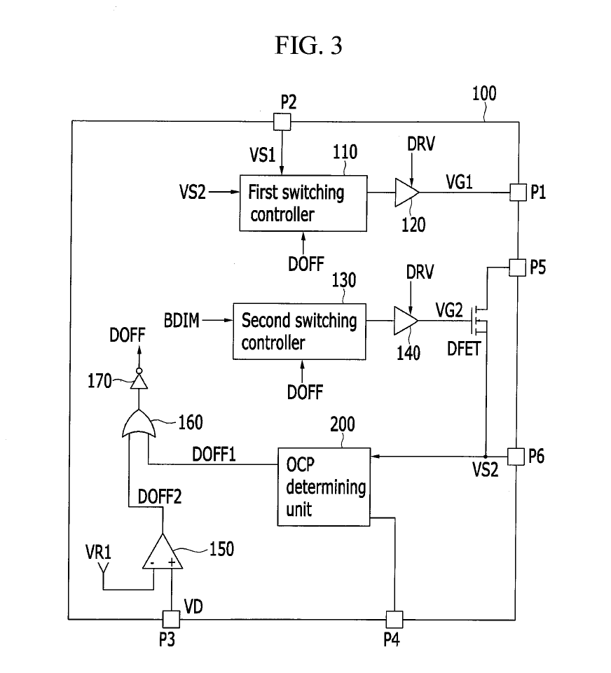

In addition, the LED driver IC 100 according to the exemplary embodiment of the present invention will be described with reference to FIG. 3.

FIG. 3 shows a configuration of the LED driver IC.

As shown in FIG. 3, the LED driver IC 100 includes a dimming switch DFET, an OCP determining unit 200, a first switching controller 110, a first gate driver 120, a second switching controller 130, a second gate driver 140, an over-voltage comparator 150, a logical operation unit 160, and an inverter 170.

The dimming switch DFET can be formed outside of the LED driver IC 100, although it is included in the LED driver IC 100 in FIG. 3. The exemplary embodiment of the present invention is not limited to this.

The first switching controller 110 receives a first sense voltage VS1 according to a drain current of the power switch M and a second sense voltage VS2 according to a drain current of the dimming switch DFET, and controls switching operation of the power switch M by comparing a voltage (hereinafter, referred to as an error amplification voltage) of which an error with the second sense voltage VS2 and a predetermined reference voltage is amplified with the first sense voltage VS1.

In further detail, the first switching controller 110 may turn off the power switch M when the first sense voltage VS1 reaches the error amplification voltage, and may turn on the power switch M by being synchronized at a rising edge (or, a falling edge) of a clock signal having a predetermined frequency. Here, the clock signal is a clock signal for determining a switching frequency of the power switch.

The first switching controller 110 is based on a costant current such that a current flowing to the LED string 300 is constantly maintained. However, the present invention is not limited thereto, and the first switching controller 110 may be changed according to a method through which the LED voltage VLED is constantly controlled. In this case, the first switching controller 110 receives a voltage (e.g., a voltage D) according to the LED voltage VLED, and may control switching operation of the power switch M by comparing an error between a predetermined voltage and an input voltage with the first sense voltage VS1.

The first switching controller 110 turns off the power switch M when a dimming off signal DOFF is in a disable-level. In the exemplary embodiment of the present invention, the disable level is a low level, and the dimming off signal DOFF is becomes disable level when the OCP or over-voltage protection (OVP) operation is triggered.

The first gate driver 120 receives an output signal of the first switching controller 110, and outputs a first gate signal VG1 according to the output signal of the first switching controller 110. When the output signal of the first switching controller 110 is a signal that turns off the power switch M, the first gate driver 120 outputs a low-level first gate signal VG1. When the output signal of the first switching controller 110 is a signal that turns on the power switch M, the first gate driver 120 outputs a high-level first gate signal VG1.

In further detail, the first gate driver 120 generates the high-level first gate signal VG1 that turns on the power switch M using a driving voltage DRV. The driving voltage DRV is generated by the power voltage VCC, and is equivalent to the power voltage VCC.

The second switching controller 130 controls the switching operation of the dimming switch DFET according to a dimming pulse signal BDIM, and turns off the dimming switch DFET according to a disable-level dimming off signal DOFF. The dimming pulse signal BDIM is a signal controlling a light emission duty of the LED string, and the second switching controller 130 turns on the dimming switch DFET while on-duty of the dimming pulse signal BDIM.

When the dimming off signal DOFF is disabled by the abnormal state such as OCP or OVP, the second switching controller 130 turns off the dimming switch DFET.

The second gate driver 140 receives an output signal of the second switching controller 130, and outputs a second gate signal VG2 according to the output signal of the second switching controller 130. When the output signal of the second switching controller 130 is a signal that turns off the dimming switch DFET, the second gate driver 140 outputs a low-level second gate signal VG2. When the output signal of the second switching controller 130 is a signal that turns on the dimming switch DFET, the second gate driver 130 outputs a high-level second gate signal VG2.

In further detail, the second gate driver 130 generates a high-level second gate signal VG2 that turns on the power switch M using the driving voltage DRV.

The OCP determining unit 200 senses the gate-source voltage in the turn-on state of the dimming switch DFET, and triggers the OCP operation when a voltage corresponding to the sensed gate-source voltage is lower than a predetermined threshold level. In the exemplary embodiment of the present invention, the gate voltage in the turn-on state of the dimming switch DFET is a voltage subtracted by a predetermined voltage drop from the driving voltage DRV, and the source voltage is the sense voltage VS2.Further, the driving voltage DRV and the power voltage VCC have the same level.

That is, the gate voltage is equivalent to a voltage subtracted from the power voltage VCC or the driving voltage DRV by the voltage drop which occurs while the power voltage VCC or the driving voltage DRV reaches the gate electrode.

Thus, occurrence of over-current due to the LED short-circuit can be sensed using the difference between the power voltage VCC (or, the driving voltage DRV) and the sense voltage VS2. In the exemplary embodiment of the present invention, the OCP determining unit 200 uses the power voltage VCC or the driving voltage DRV to measure the gate voltage, but the present invention is not limited thereto. For example, the OCP determining unit 200 may directly measure the gate voltage.

The OCP determining unit 200 determines LED short-circuit when the difference between the two voltages is lower than a first OCP reference voltage, and generates a first dimming off signal DOFF1 having a level (i.e., enable level) that triggers the OCP operation. The first dimming off signal DOFF1 that triggers the OCP operation is high level.

The OCP determining unit 200 resets the first dimming off signal DOFF1 for auto-restart for every predetermined period unit. In addition, the OCP determining unit 200 senses occurrence of over-current by comparing the second sense voltage VS2 with a second OCP reference voltage.

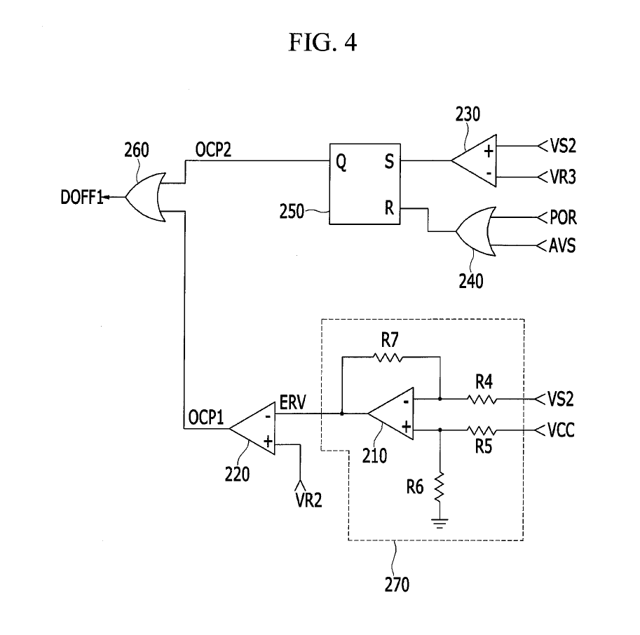

Referring to FIG. 4, the OCP determining unit 200 will be described in further detail.

FIG. 4 shows the OCP determining unit according to the exemplary embodiment of the present invention.

As shown in FIG. 4, the OCP determining unit 200 includes an error amplifier 210, a first OCP comparator 220, a second OCP comparator 230, an SR flip-flop 250, a restart logic gate 240, and a dimming off logic gate 260.

The error amplifier 210 generates an error voltage ERV according to the difference between the second sense voltage VS2 and the power voltage VCC. The error amplifier 210 includes an inversion terminal (−) to which the second sense voltage VS2 is transmitted and a non-inversion terminal (+) to which the power voltage VCC is transmitted.

The resistor R4 is connected between the inversion terminal (−) of the error amplifier 210 and the second sense voltage VS2, a resistor R7 is connected between the inversion terminal (−) of the error amplifier 210 and an output terminal thereof, a resistor R5 is connected between the non-inversion terminal (+) of the error amplifier 210 and the power voltage VCC, and a resistor R6 is connected between the non-inversion terminal (+) of the error amplifier 210 and the ground.

When the four resistors R4 to R7 have the same resistance values, the error voltage ERV of the error amplifier 210 is a voltage obtained by subtracting the second sense voltage VS2 from the power voltage VCC. In the exemplary embodiment of the present invention, the error voltage ERV is set to be a (power voltage VCC-sense voltage VS2) voltage for convenience of description.

The first OCP comparator 220 generates a high-level first OCP signal OCP1 when the error voltage ERV is lower than the first OCP reference voltage VR2 by comparing the error voltage ERV with the first OCP reference voltage VR2. When the error voltage ERV is not lower than the first OCP reference voltage VR2, the first OCP comparator 220 generates a low-level first OCP signal OCP1. According to the high-level first OCP signal OCP1, each of the first and second switching controllers 110 and 120 stops switching operation of the dimming switch DFET and the power switch M.

The first OCP comparator 220 includes an inversion terminal (−) to which the error voltage ERV is input and a non-inversion terminal (+) to which the first OCP reference voltage VR2 is input, and outputs the first OCP signal OPC1 generated according to the comparison result.

The second OCP comparator 230 compares the second sense voltage VS2 and the second OCP reference voltage VR3, and generates a high-level output when the second sense voltage VS2 is higher than the second OCP reference voltage VR3. In the opposite case, the second OCP comparator 230 generates a low-level output.

The SR flip-flop 250 generates a high-level second OCP signal OCP2according to an output of the second OCP comparator 230, input to a set terminal S, and generates a low-level second OCP signal OCP2 according to an output of a restart logic gate 240, input to a reset terminal R. According to the high-level second OCP signal OCP2, each of the first and second switching controllers 110 and 120 stops the switching operation of the dimming switch DFET and the power switch M.

In further detail, the SR flip-flop 250 generates a high-level second OCP signal OCP2 when the output of the second OCP comparator 230 is high level, and when the output of the second OCP comparator 230 is low level, the SR flip-flop 250 generates a low-level second OCP signal OCP2.

The restart logic gate 240 receives a power reset signal POR and an auto-restart signal AVS, and generates an output for resetting the second OCP signal OCP to restart the switching operation of the dimming switch DFET and the power switch M when at least one of the two received signals is enable-level.

The power reset signal POR is a signal generated when the AC input is blocked and then supplied again, and the auto-restart signal AVS is a signal for restarting of the switching operation of the dimming switch DFET and the power switch M with a predetermined cycle in order to detect whether an abnormal state is continued under a condition that the abnormal state occurs and thus a protection operation is triggered.

The restart logic gate 240 performs an XOR operation, and therefore, when at least one of the power reset signal POR and the auto-restart signal AVS is high level, the restart logic gate 240 outputs a high-level signal to the reset terminal R of the SR flip-flop 250 to reset, that is, to change the second OCP signal OCP2 to low level.

The dimming off logic gate 260 generates an enable-level first dimming off signal DOFF1 when at least one of the first OCP signal OCP1 and the second OCP signal OCP2 is enable level that stops the switching operation. The dimming switch DFET and the power switch M are turned off according to the enable-level first dimming off signal DOFF1.

Since the dimming off logic gate 260 operations an XOR operation, the dimming off logic gate 260 generates a high-level first dimming off signal DOFF1 when at least one of the first OCP signal OCP1 and the second OCP signal OCP2 is high level.

The over-voltage comparator 150 generates a second dimming off signal DOFF2 according to a comparison between a divided voltage VD and an over-voltage reference voltage VR1. The over-voltage comparator 150 includes a non-inversion terminal (+) to which the divided voltage VD is input and an inversion terminal (−) to which the over-voltage reference voltage VR1 is input.

The over-voltage comparator 150 generates a high-level second dimming off signal DOFF2 when an input of the non-inversion terminal (+) is higher than an input of the inversion terminal (−), and generates a low-level second dimming off signal DOFF2 in the opposite case.

The logical operation unit 160 outputs an enable-level signal when at least one of the first dimming off signal DOFF1 and the second dimming off signal DOFF2 is enable level. The logical operation unit 160 is realized as an OR gate performing an XOR operation.

The inverter 170 generates a dimming off signal DOFF by inverting an output signal of the logical operation unit 160. The dimming off signal DOFF is generated as a disable-level signal according to the first dimming off signal DOFF1 or the enable-level second dimming off signal DOFF2.

As previously stated, the first switching controller 110 and the second switching controller 130 turn off the power switch M and dimming switch DFET according to the disable-level dimming off signal DOFF.

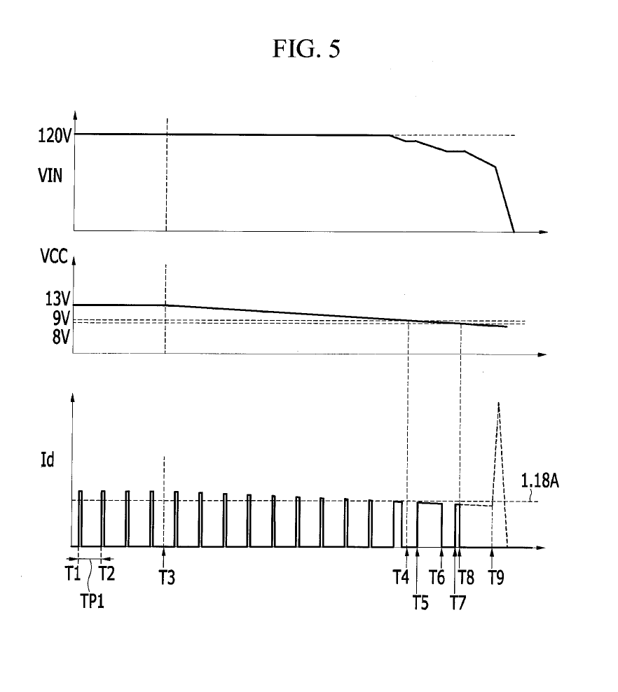

Hereinafter, the operation of the LED drive IC 100 according to the exemplary embodiment of the present invention will be described with reference to FIG. 5.

FIG. 5 is a waveform diagram of an input voltage, a power voltage, and a drain current according to the exemplary embodiment of the present invention. FIG. 5 is a waveform diagram of an input voltage, a power voltage, and a drain current after the OCP operation is triggered.

At a time point T1 shown in FIG. 5, the dimming switch DFET and the power switch M are turned on by the auto-restart signal AVS and thus a drain current Id is generated. When the drain current Id reaches an overcurrent reference level of 1.18 A, the dimming off signal DOFF is generated again and the dimming switch DFET is turned off.

The sense voltage VS2 becomes higher than the second OCP reference voltage VR3 by the drain current Id generated at the time point T1. A high-level signal is input to the set terminal S of the SR flip-flop 250, the first OCP signal OCP1 becomes high level, and the first dimming off signal DOFF1 becomes high level. Then, the dimming off signal DOFF becomes low level and thus the first switching controller 110 and the second switching controller 130 turn off the power switch M and the dimming switch DFET.

The power switch M and the dimming switch DFET are turned on by the auto-restart signal AVS for every period TP1. At a time point T2, the drain current Id is generated, the sense voltage VS2 becomes higher than the second OCP reference voltage VR3, and the SR flip-flop 250 outputs a high-level first dimming off signal DOFF1. Then, the dimming off signal DOFF becomes low level and thus the first switching controller 110 and the second switching controller 130 turn off the power switch M and the dimming switch DFET.

The auto-restart operation is iteratively occurred during the OCP operation. In addition, the auto-restart operation is iteratively occurred during an OVP operation that is triggered due to over-voltage of the LED voltage VLED.

At a time point T3, the AC input is blocked and thus input voltage VIN is maintained with a constant level for a predetermined period as described above, and the power voltage VCC is decreased.

After the time point T3, the auto-restart operation is iterated for every period TP1. When the decreasing power voltage VCC is decreased to a ULVO voltage of 9V at a time point T4, the OCP operation may not be normally performed.

For example, at a time point T5, the dimming switch DFET and the power switch M are turned on by the auto-restart signal AVS, and the drain current Id is low due to the low power voltage VCC such that the OCP operation is not operated. At a time point T6, the dimming switch DFET is turned off by the dimming pulse signal BDIM. The maximum duty of the power switch M is controlled to turn off the power switch M before the next auto-restart time point.

For example, in the exemplary embodiment of the present invention, the maximum duty of the power switch M is set to be lower than the pulse width of the dimming pulse signal BDIM. Thus, the power switch M is turned off before the time point T6.

At a time point T7, the dimming switch DFET and the power switch M are turned on by the auto-restart signal AVS, and the error voltage that corresponds to a difference between the power voltage VCC and the sense voltage VR2 becomes lower than the first OCP reference voltage VR2 at a time point T8. Then, the first dimming off signal DOFF1 becomes high level and the dimming off signal DOFF becomes low level by the high-level first OCP signal OCP1.

FIG. 5 illustrates that the error voltage EVR becomes the first OCP reference voltage VR2 when the power voltage VCC reaches 8V (at the time point T8).

At the time point T8, the first switching controller 110 and the second switching controller 130 turn off the power switch M and the dimming switch DFET according to the low-level dimming off signal DOFF.

After the time point T8, the waveform of the drain current Id, marked by the dotted line is not the exemplary embodiment of the present invention but a peak current generated from a conventional LED driver IC.

In case of the conventional LED driver IC, the OCP operation is not normally performed after the time point T4, and thus the dimming switch is turned off by the dimming pulse signal. However, the dimming switch cannot deal with stress due to an input voltage and thus the dimming switch may be damaged before the dimming switch is turned off by the dimming pulse signal after the auto-restart operation is performed at the time point T7.

Then, a current flowing to the LED string in the short-circuit stated continuously flows into the damaged dimming switch, and as shown in FIG. 5, the peak current may flow to the dimming switch at a time point T9.

The LED driver IC 100 according to the exemplary embodiment of the present invention turns off the power switch M and the dimming switch DFET when the error voltage EVR that corresponds to the difference between the power voltage VCC and the sense voltage VS2 becomes lower than the first OCP reference voltage VR2 so as to prevent the above-stated problem of the conventional LED driver IC.

The error voltage ERV may be generated using a voltage-current converter rather than using the error amplifier 210 of the OCP determining unit 200 and an error amplifying unit 270 formed of the resistors R4 to R7.

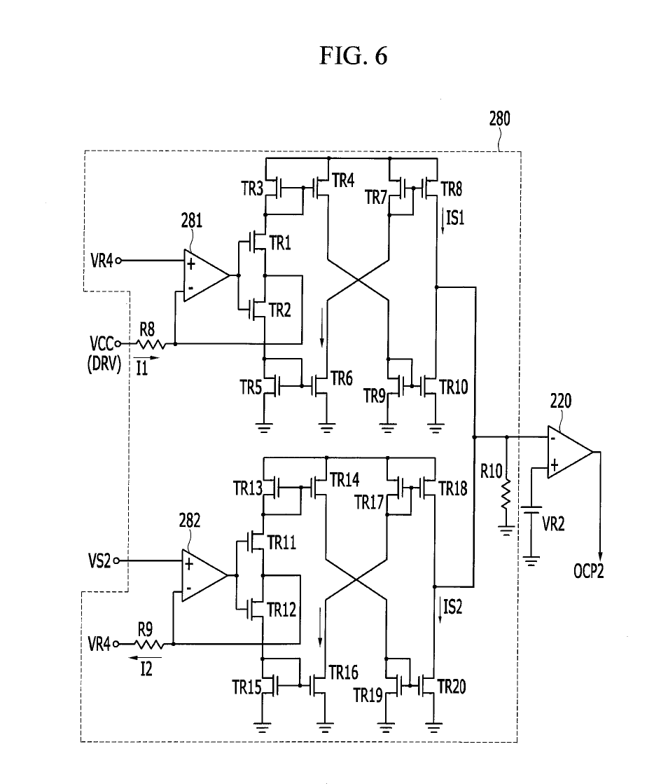

FIG. 6 shows a voltage-current converter according to another exemplary embodiment of the present invention.

In a voltage-current converter 280 shown in FIG. 6, an OCP determining unit 200 receives a sense voltage VS2 and a power voltage VCC (or, a driving voltage DRV) instead of an error amplifying unit 270 and generates an error voltage ERV using the difference between the two voltages.

The voltage current converter 280 includes a first error amplifier 281, a second error amplifier 282, and a plurality of transistors TR1 to TR10 and TR11 to TR20.

The first error amplifier 281 includes an inversion terminal (−) connected with the power voltage VCC (or., the driving voltage DRV) through the resistor R8 and a non-inversion terminal (+) to which a reference voltage VR4 is input, and amplifies a voltage difference between the two terminals and supplies the amplified value to gate electrodes of the transistors TR1 and TR2.

The transistor TR5 includes a drain electrode connected to a drain electrode of the transistor TR2, a source electrode connected to a ground, and a gate electrode connected to the drain electrode. A transistor of which a drain electrode and a gate electrode are connected with each other is a diode. Hereinafter, a structure in which a drain electrode and a gate electrode are connected with each other is referred to a diode-connected structure.

The transistor TR6 including a gate electrode connected to the gate electrode of the transistor TR5 and a source electrode connected to the ground and the transistor TR5 form a first current mirror circuit.

The transistor TR7 including a drain electrode connected to the drain electrode of the transistor TR6 and a source electrode connected to a predetermined voltage VB are diode-connected. In addition, a gate electrode of the transistor T8 is connected to the gate electrode of the transistor TR7 such that a second current mirror circuit is formed.

That is, a current flowing to the transistor TR2 is mirrored by the first current mirror circuit, and the current mirrored by the first current mirror circuit is mirrored by the second current mirror circuit and thus becomes a source current flowing to a node N1 from the voltage VB.

The transistor TR3 includes a drain electrode connected to the drain electrode of the transistor TR1, a source electrode connected to the voltage VB, and a gate electrode connected to the drain electrode.

The transistor TR4 including a gate electrode connected to the gate electrode of the diode-connected transistor TR3 and a source electrode connected to the voltage VB and the transistor TR3 form a third current mirror circuit.

The transistor TR9 including a drain electrode connected to the drain electrode of the transistor TR4 and a source electrode connected to the ground is diode-connected. In addition, a gate electrode of the transistor TRW is connected to the gate electrode of the transistor TR9 such that a fourth current mirror circuit is formed.

That is, a current flowing to the transistor TR1 is mirrored by the third current mirror circuit, and the current mirrored by the third current mirror circuit is mirrored by the fourth current mirror circuit and thus becomes a sink current flowing from the node N1 to the ground.

The second error amplifier 282 includes an inversion terminal (−) connected to the reference voltage VR4 through the resistor R9 and a non-inversion terminal (+) to which the sense voltage VS2 is input, and amplifies a voltage difference between the two terminals and supplies the amplified value to gate electrodes of the transistors TR11 and TR12.

The transistor TR15 includes a drain electrode connected to a drain electrode of the transistor TR12, a source electrode connected to the ground, and a gate electrode connected to the drain electrode.

The transistor TR16 including a gate electrode connected to the gate electrode of the diode-connected transistor TR15 and a source electrode connected to the ground and the transistor TR15 form a fifth current mirror circuit.

The transistor TR17 including a drain electrode connected to the drain electrode of the transistor TR16 and a source electrode connected to the voltage VB is diode-connected. In addition, a gate electrode of the transistor T18 is connected to the gate electrode of the transistor TR17 such that a sixth current mirror circuit is formed.

That is, a current flowing to the transistor TR12 is mirrored by the fifth current mirror circuit, and the current mirrored by the fifth current mirror circuit is mirrored by the sixth current mirror circuit and thus becomes a source current flowing to the node N1 from the voltage VB.

The transistor TR13 includes a drain electrode connected to the drain electrode of the transistor TR11, a source electrode connected to the voltage VB, and a gate electrode connected to the drain electrode.

The transistor TR14 including a gate electrode connected to the gate electrode of the diode-connected transistor TR13 and a source electrode connected to the voltage VB and the transistor TR13 form a seventh current mirror circuit.

The transistor TR19 including a drain electrode connected to the drain electrode of the transistor TR14 and a source electrode connected to the ground is diode-connected. In addition, a gate electrode of the transistor TR20 is connected to the gate electrode of the transistor TR19 such that an eighth current mirror circuit is formed.

That is, a current flowing to the transistor TR11 is mirrored by the seventh current mirror circuit, and the current mirrored by the seventh current mirror circuit is mirrored by the eighth current mirror circuit and thus becomes a sink current flowing to the ground.

When the first error amplifier 281 is ideally operated, a voltage of the non-inversion terminal (−) and a voltage of the inversion terminal (+) are equivalent to each other. When the power voltage VCC is higher than the reference voltage VR4, a current I1 flows to a direction passing through the resistor R8 from the power voltage VCC.

In this case, an output of the first error amplifier 281 turns on the transistor TR2, and accordingly the current I1 flows to the transistor TR2. The current I1 becomes a source current IS1 mirrored by the first current mirror circuit and the second current mirror circuit and thus flowing to the node N1.

When the second error amplifier 282 is ideally operated, a voltage of the non-inversion terminal (−) and a voltage of the inversion terminal (+) are also equivalent to each other. When the sense voltage VS2 is higher than the reference voltage VR4, the current I2 flows to the resistor R9.

In this case, an output of the second error amplifier 282 turns on the transistor TR11, and accordingly, the current I2 flows to transistor TR11. The current I2 is mirrored through the seventh current mirror circuit and the eighth current mirror circuit and thus becomes a sink current IS2 flowing to the ground.

In the exemplary embodiment of the present invention, a mirror ratio of the first to eighth current mirror circuits is set to 1:1. Then, the source current IS1 is equivalent to the current I1, and the sink current IS2 is equivalent to the current I2.

The current I1 is (VCC−VR4)/R8, current I2 is (VS2−VR4)/R9, and a current flowing to the resistor R10 is (IS1−IS2). In this case, when the resistor R8 and the resistor R9 are equivalent to each other, the current flowing to the resistor R10 becomes (VCC−VS2)/R8.

In addition, when the resistor R10 is also equivalent to the resistor R8 (=R9), a voltage of the node N1 becomes (VCC−VS2), that is, a difference between the power voltage VCC and the sense voltage VS2.The voltage of the node N1 is an error voltage ERV, and the error voltage ERV is input to the inversion terminal (−) of the first OCP comparator 220.

As in the previous-stated exemplary embodiment, when the error voltage ERV becomes lower than the first OCP reference voltage VR2 due to decrease of the power voltage VCC, a high-level first OCP signal OCP1 is generated.

A first dimming off signal DOFF1 becomes high-level by the high-level first OCP signal OCP1, and an output of a logic gate 160 becomes high level. An inverter 170 inverts the high-level output of the logic gate 160 and thus a disable-level (i.e., low-level) dimming off signal DOFF is generated.

When the dimming switch DFET is in the turn-off state, the reference voltage VR4 is higher than the sense voltage VS2, and therefore, the current I2 becomes VR4/R9 (i.e., the current flows opposite to the arrow direction) and a source current supplied to the node N1, and the current flowing to the resistor R10 is increased and thus the voltage of the node N1 becomes further higher than the case that the dimming switch DFET is turned on. Thus, malfunction due to the turn-off of the dimming switch DFET does not occur.

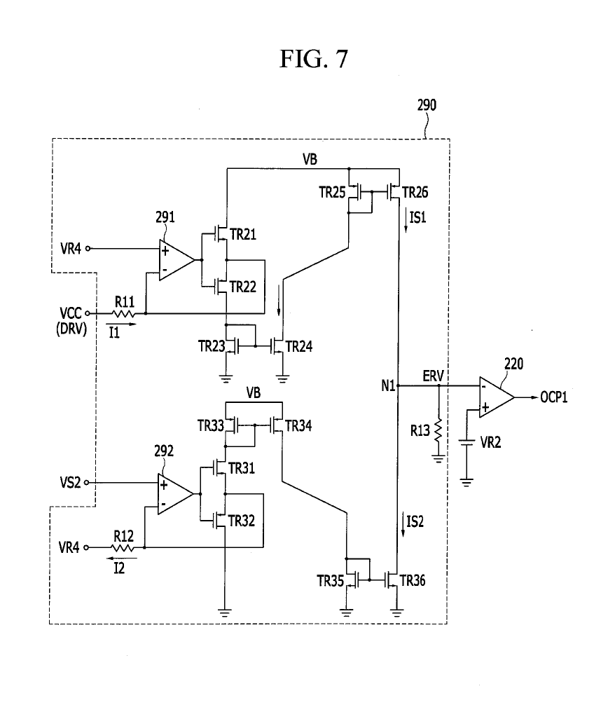

FIG. 7 shows a voltage-current converter according to another exemplary embodiment of the present invention.

A voltage-current converter 290 of FIG. 7 receives a sense voltage VS2 and a power voltage VCC (or, a driving voltage DRV) instead of an error amplifier 270 and generates an error voltage ERV using a difference between the two voltages.

The number of current mirror circuits of the voltage-current converter 290 of FIG. 7 is smaller than that of the voltage-current converter 280 of FIG. 6. For example, among eight current mirror circuits of the voltage-current converter 280, only the first current mirror circuit, the second current mirror circuit, the seventh current mirror circuit, and the eighth current mirror circuit are included.

As shown in FIG. 7, the voltage-current converter 290 includes a third error amplifier 291, a fourth error amplifier 292, and a plurality of transistors TR1 to TR10 and TR11 to TR20.

The third error amplifier 291 includes an inversion terminal (−) connected to the power voltage VCC (or, the driving voltage DRV) through the resistor R11 and a non-inversion terminal (+) to which the reference voltage VR4 is input, and amplifies a voltage difference between the two terminals and supplies the amplified value to gate electrodes of the transistors TR21 and TR22.

The transistor TR23 includes a drain electrode connected to a drain electrode of the transistor TR22, a source electrode connected to the ground, and a gate electrode connected to the drain electrode.

The transistor TR24 including a gate electrode connected to the gate electrode of the transistor TR23 and a source electrode connected to the ground and the transistor TR23 form a first current mirror circuit.

The transistor TR25 including a drain electrode connected to the drain electrode of the transistor TR24 and a source electrode connected to the voltage VB is diode-connected. In addition, a gate electrode of the transistor TR26 is connected to the gate electrode of the transistor TR25 such that a second current mirror circuit is formed.

That is, a current flowing to the transistor TR22 is mirrored by the first current mirror circuit, and the current mirrored by the first current mirror circuit is mirrored by the second current mirror circuit and thus becomes a source current IS1 flowing to the node N1.

The fourth error amplifier 292 includes an inversion terminal (−) connected with the reference voltage VR4 through the resistor R12 and a non-inversion terminal (+) to which the sense voltage VS2 is input, and amplifies a voltage difference between the two terminals and supplies the amplified value to gate electrodes of the transistors TR31 and TR32.

The transistor TR33 including a drain electrode connected to the drain electrode of the transistor TR31 and a source electrode connected to the voltage VB is diode-connected. In addition, a gate electrode of the transistor T34 is connected to the gate electrode of the transistor TR33 such that a seventh current mirror circuit is formed.

The transistor TR35 including a drain electrode connected to the drain electrode of the transistor TR34 and a source electrode connected to the graoun is diode-connected. In addition, a gate electrode of the transistor T36 is connected to the gate electrode of the transistor TR35 such that an eighth current mirror circuit is formed.

That is, a current flowing to the transistor TR31 is mirrored by the seventh current mirror circuit, and the current mirrored by the seventh current mirror circuit is mirrored by the eighth current mirror circuit and thus becomes a sink current IS2 flowing to the ground.

When the third error amplifier 291 is in the ideal condition, the current I1 flows to a direction passing through the resistor R11 from the power voltage VCC when the power voltage VCC is higher than the reference voltage VR4.

In this case, an output of the third error amplifier 291 turns on the transistor TR22, and therefore the current I1 flows in the transistor TR22. The current I1 is mirrored through the first current mirror circuit and the second current mirror circuit and thus becomes the source current IS1 flowing to the node N1.

When the fourth error amplifier 292 is also in the ideal condition, a voltage of the non-inversion terminal (−) and a voltage of the inversion terminal (+) are equivalent to each other. When the sense voltage VS2 is higher than the reference voltage VR4, the current I2 flows in the resistor R12.

In this case, since an output of the fourth error amplifier 292 turns on the transistor TR31, the current I2 flows in the transistor TR31. The current I2 is mirrored through the seventh current mirror circuit and the eighth current mirror circuit and thus becomes the sink current IS2 flowing to the ground.

A mirror ratio of all current mirror circuits according to another exemplary embodiment of the present invention is set to 1:1. Then, the source current IS1 is equivalent to the current I1, and the sink current IS2 is equivalent to the current I2.

The current I1 is (VCC−VR4)/R11, the current I2 is (VS2−VR4)/R12, and the current flowing in the resistor R13 is (IS1−IS2). In this case, when the resistor R11 and the resistor R12 are equivalent to each other, the current flowing in the resistor R13 becomes (VCC31 VS2)/R11.

In addition, when the resistor R13 is also equivalent to the resistor R11 (=R12), the voltage of the node N1 becomes (VCC−VS2), that is, a difference between the power voltage VCC and the sense voltage VS2. The voltage of the node N1 is an error voltage ERV, and the error voltage ERV is input to the inversion terminal (−) of the first OCP comparator 220.

As described, as in the previously-stated exemplarily embodiment, when the error voltage ERV becomes lower than the first OCP reference voltage VR2 due to decrease of the power voltage VCC, a high-level first OCP signal OCP1 is generated.

A first dimming off signal DOFF1 becomes high level by the high-level first OCP signal OCP1 and an output of a logic gate 160 becomes high level. An inverter 170 inverts the high-level output of the logic gate 160, and thus a disable-level (i.e., low-level) dimming off signal DOFF is generated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

transistor (TR1-TR10, TR11-TR20, TR21-TR26, TR31-TR36)

first to fourth error amplifier (281, 282, 291, 292), error amplifier 210

error amplifying unit 270, sense resistor RS1 and RS2, resistor (R1-R13)

voltage-current converter 280 and 290, power switch M, dimming switch DFET

LED light emitting device 1, LED driver IC 100, boost converter 20

LED string 300, inductor L, rectification diode D, capacitor C1 and C2

OCP determining unit 200, first switching controller 110, first gate driver 120

second switching controller 130, second gate driver 140, over-voltage comparator 150

logical operation unit 160, inverter 170, first OCP comparator 220

second OCP comparator 230, SR flip-flop 250, restart logic gate 240

dimming off logic gate 260

What is claimed is:

1. An LED driver IC controlling light emission of an LED string and controlling switching operation of a power switch that controls power supplied to the LED string, comprising,
a dimming switch including a first electrode connected to the LED string and a second electrode connected to a sense resistor, and
an OCP determining unit sensing a difference between a voltage corresponding to a control electrode voltage of the dimming switch and a sense voltage generated according to a current flowing to the sense resistor and triggering over-current protection (OCP) operation according to a comparison result of the sensed voltage difference with a predetermined first OCP reference voltage.

2. The LED driver IC of claim 1, wherein the voltage corresponding to the control electrode voltage of the dimming switch is a power voltage for operation of the LED driver IC, and
the OCP determining unit generates an error voltage according to a voltage obtained by subtracting the sense voltage from the power voltage and generates a first dimming off signal that triggers the OCP operation according to a comparison result of the error voltage with the first OCP reference voltage.

3. The LED driver IC of claim 2, wherein the OCP determining unit comprises:
an error amplification unit including a first terminal to which the power voltage is input through a first resistor, a second terminal to which a voltage divided from the sense voltage by second and third resistors is input, and an output terminal connected with the first terminal through a fourth resistor, and generating an error voltage obtained by subtracting an input of the second terminal from an input of the first terminal; and
a first OCP comparator including a first terminal to which the first OCP reference voltage is input and a second terminal to which the error voltage is input, and generating a first OCP signal that commands triggering of the OCP operation when the input of the first terminal is higher than the input of the second terminal.

4. The LED driver IC of claim 3, wherein the OCP determining unit further comprises:
a second OCP comparator generating a second OCP signal according to a comparison result of the sense voltage and a second OCP reference voltage that is different from the first OCP reference voltage; and
an SR flip-flop including a reset terminal to which a signal corresponding to an auto-restart signal that controls auto-restart after the OCP operation is triggered and a set terminal to which an output of the second OCP comparator is input, generating a second OCP signal that commands triggering of the OCP operation according to an input of the set terminal, and resetting the second OCP signal according to an input of the reset terminal.

5. The LED driver IC of claim 4, wherein the OCP determining unit further comprises a dimming off logic gate performing a logic operation on the first OCP signal and the second OCP signal, and generating the first dimming off signal when one of the first and second OCP signals commands the triggering of the OCP operation.

6. The LED driver IC of claim 5, further comprising an over-voltage comparator generating a second dimming off signal that triggers the OCP operation when a voltage corresponding to an LED voltage supplied to the LED string is higher than a predetermined over-voltage reference voltage, and
when the first and second dimming off signals performs the logic operation and thus one of the two signals triggers the OCP operation, a dimming off signal that turns off the power switch and the dimming switch is generated.

7. The LED driver IC of claim 2, wherein the OCP determining unit comprises
a voltage-current converter generating the error voltage and
a first OCP comparator including a first terminal to which the first OCP reference voltage is input and a second terminal to which the error voltage is input, and generating a first OCP signal that commands triggering of the OCP operation when an input of the first terminal is higher than an input of the second terminal, and
the voltage-current converter comprises,
a first error amplifier including a first terminal connected with the power voltage through a fifth resistor and a second terminal to which a predetermined reference voltage is input, and generating an output according to a voltage difference between the two terminals,
a second error amplifier including a first terminal to which the reference voltage is input through a sixth and a second terminal to which the sense voltage is input, and generating an output according to a voltage difference between the two terminals,
first and second transistors having gate electrodes to which the output of the first error amplifier is input,
a first current mirror circuit mirroring a current flowing to the second transistor,
a second current mirror circuit mirroring the current mirrored through the first current,
third and fourth transistors having gate electrodes to which an output of the second error amplifier is input,
a seventh current mirror circuit mirroring a current flowing to the third transistor,
an eighth current mirror circuit mirroring the current mirrored through the seventh current mirror circuit, and
a seventh resistor including a first terminal connected a node where the second current mirror circuit and the eighth current mirror circuit are connected and the second terminal of the first OCP comparator and a second terminal connected to a ground, and
a node of the first transistor and the second transistor is connected to the first terminal of the first error amplifier, a node of the third transistor and the fourth transistor is connected to the first terminal of the second error amplifier, and the error voltage is a first terminal voltage of the seventh resistor.

8. The LED driver IC of claim 7, wherein the voltage-current converter further comprises:
a third current mirror circuit mirroring a current flowing to the first transistor,
a fourth current mirror circuit mirroring the current mirrored through the third current mirror circuit,
a fifth current mirror circuit mirroring a current flowing to the fourth transistor, and
a sixth current mirror circuit mirroring the current mirrored through the fifth current mirror circuit.

9. The LED driver IC of claim 1, comprising:
a switching controller controlling switching operation of the dimming switch according to a dimming pulse signal that controls light emission duty of the LED string, and turning off the dimming switch by being synchronized by the first dimming off signal; and
a gate driver generating a gate signal according to an output of the switching controller using a driving voltage and transmitting the gate signal to a control electrode of the dimming switch,
wherein a voltage corresponding to a control electrode of the dimming switch is the driving voltage.

10. The LED driver IC of claim 9, wherein the OCP determining unit generates an error voltage according to a voltage obtained by subtracting the sense voltage from the driving voltage and generates a first dimming off signal that triggers the OCP operation according to a comparison result of the error voltage and the first OCP reference voltage, and the driving voltage corresponds to a power voltage for operation of the LED driver IC.

11. The LED driver IC of claim 1, further comprising a switching controller turning off the power switch by being synchronized by the first dimming off signal.

12. The LED driver IC of claim 11, wherein the switching controller turns off the power switch when a voltage generated according to a current flowing to the power switch reaches an error amplification voltage generated according to a difference between the sense voltage and a predetermined reference voltage, and turns on the power switch according to a clock signal that controls switching operation of the power switch.

13. A driving method of an LED driver IC controlling switching operation that controls a power switch controlling power supplied to an LED driver and a dimming switch controlling light emission of the LED string, comprising:
generating a difference between a voltage corresponding to a control electrode voltage of the dimming switch and a sense voltage generated according to a current flowing to a sense resistor;
comparing the difference of the voltages with a predetermined first OCP reference voltage; and
turning off the power switch and the dimming switch by triggering OCP operation according to a result of the comparison.

14. The driving method of claim 13, wherein the voltage corresponding to the control electrode voltage of the dimming switch is a power voltage for operation of the LED driver IC, and the generating of the difference of the voltages comprises generating an error voltage according to a voltage obtained by subtracting the sense voltage from the power voltage.

15. The driving method of claim 14, wherein the comparing with the first OCP reference voltage comprises generating a first OCP signal commanding triggering of the OCP operation when the first OCP reference voltage is higher than the error voltage.

16. The driving method of claim 15, further comprising:
generating a second OCP signal that depends on a result of comparison between the sense voltage and a second OCP reference voltage that is different from the first OCP reference voltage;
auto-restarting that turns on the dimming switch and the power switch for every period unit after the OCP operation is being triggered; and
terminating the auto-restart by the second OCP signal commanding triggering of the OCP operation or the first OCP signal commanding triggering of the OCP operation.

17. The driving method of claim 13, wherein the voltage corresponding to the control electrode of the dimming switch is a driving voltage supplying a voltage that turns on the dimming switch or the power switch.

18. An LED light emission device comprising:
an LED string;
a power switch supplying power to the LED string;
a dimming switch controlling light emission duty of the LED string; and
an LED driver IC controlling switching operation of the power switch and the dimming switch,
wherein the LED driver IC senses a difference between a voltage corresponding to a control electrode voltage of the dimming switch and a sense voltage generated according to a current flowing to a dimming FET and triggers OCP operation according to a comparison result of the sensed voltage and a predetermined first OCP reference voltage.

19. The LED light emission device of claim 18, wherein the voltage corresponding to the control electrode voltage of the dimming switch is a power voltage for operation of the LED driver IC, and the LED driver IC generates an error voltage according to a voltage obtained by subtracting the sense voltage from the power voltage and triggers the OCP operation according to a result of comparison between the error voltage and the first OCP reference voltage.

20. The LED light emission device of claim 18, wherein the voltage corresponding to the control electrode voltage of the dimming switch is a driving voltage supplying a voltage that turns on the dimming switch or the power switch, and the LED driver IC generates an error voltage according to a voltage obtained by subtracting the sense voltage from the driving voltage and triggers the OCP operation according to the comparison result of the error voltage and the first OCP reference voltage.
